(19) United States
(12) Patent Application Publication
(10) Pub. No.: US 2011/0097260 A1
(43) Pub. Date: Apr. 28, 2011

(54) Hydrogen Recovery And Methane Production From Residual Fuels and Biomass

(75) Inventors: Dennis A. Vauk, Houston, TX (US); Bhadra S. Grover, Sugar Land, TX (US)

(73) Assignee: Air Liquide Process & Construction, Inc., Houston, TX (US)

(21) Appl. No.: 12/607,605

(22) Filed: Oct. 28, 2009

(51) Int. Cl. C01B 3/30

(52) U.S. Cl. 423/658.2

(57) ABSTRACT

A method of hydrogen and methane recovery from syngas from a gasifier is provided. Then directing a raw syngas stream from an acid gas removal system to a CO and methane removal system. Then returning the CO and methane stream to the gasifier, and exporting the hydrogen stream as a product.

This method may include exchanging heat between a raw syngas stream from an acid gas removal system, a separated CO and methane stream, a separated hydrogen stream and a liquid nitrogen stream in a heat exchanger. Then directing the cooled raw syngas stream to a cryogenic Then returning the warmed separated CO and methane stream to the gasifier, and exporting the vaporized nitrogen stream as product.

### BACKGROUND

Hydrogen is most often manufactured using natural gas as a feedstock through the steam methane reforming process. With the current high prices of natural gas it is preferred to manufacture hydrogen from lower cost sources of fuel such as residual fuels. Residual fuels from refineries consist of petroleum coke, visbreaker tar, pitch from deasphalting processes, vacuum residues, atmospheric residues and similar fuels. Coal is also a desirable low cost fuel that can be used to produce hydrogen.

The typical method of producing hydrogen from residual fuels or coal is to gasify it by partially oxidizing it by contact with oxygen and steam or water at elevated temperatures to form a syngas. The syngas consists of hydrogen, carbon monoxide, methane and carbon dioxide. Higher quantities of hydrogen are usually produced by further reacting the syngas with steam over a catalyst to promote the water gas shift reaction of carbon monoxide and steam to hydrogen and carbon dioxide.

After the removal of acid gases such as hydrogen sulfide and carbon dioxide in processes such as amine contactors, Selexol or Rectisol units, the hydrogen still needs to be purified. Hydrogen can be further purified to remove residual amounts of Carbon monoxide through a catalytic reaction to form methane (methanation) and water. This will produce a final product hydrogen stream with about 97% purity. The remaining composition is methane, nitrogen and argon. If higher purity hydrogen (>99%) is desired, the hydrogen is further processed through a Pressure Swing Adsorption (PSA). Due to the limits of PSA technology, the typical hydrogen recovery is about 87-90%.

FIG. 1 shows a typical hydrogen production from a gasifier with methanation for the final hydrogen purification as known in the prior art. For this process, the hydrogen recovery is near 100%, but the purity is limited by the purity of the oxygen coming in and the degree of conversion in the shift reactor. Typical purity would be about 97%. The disadvantage of this process is that hydrogen purity is significantly lower than that expected by refiners. Refiners have designed their processes for 99.9% purity hydrogen that can be obtained from a PSA. The lower purity is a disadvantage for using methanation as the final purification of the hydrogen.

FIG. 2 shows a typical hydrogen production from a gasifier with PSA for hydrogen purification as known in the prior art. With a PSA, recovery of hydrogen is limited to about 87-90% for production of 99.9% purity hydrogen. In order to increase the recovery of hydrogen, a recycle compressor can be added to route the tail gas back to the PSA. With recycle, the recovery can be increased to about 92-95%. The ultimate recovery is limited by the amount of purge that needs to be taken to remove the methane, and residual carbon monoxide (from the gasifier and shift reactions), and nitrogen and argon that are brought in with the oxygen.

The present invention provides a process for producing pure hydrogen and recovering methane from gasifier syngas.

### SUMMARY

In one embodiment of the present invention a method of hydrogen purification and methane recovery from syngas from a gasifier is provided. This method includes directing a raw syngas stream from an acid gas removal system, the raw syngas stream comprising CO, methane, water, and hydrogen stream to a CO and methane removal system, thereby producing pure hydrogen stream and a stream comprising CO and methane. This method also includes returning the CO and methane stream to the gasifier, and exporting the hydrogen stream as a product.

### BRIEF DESCRIPTION OF THE FIGURES

FIG. 1 illustrates a typical hydrogen production from a gasifier with methanation for the final hydrogen purification as known in the prior art.

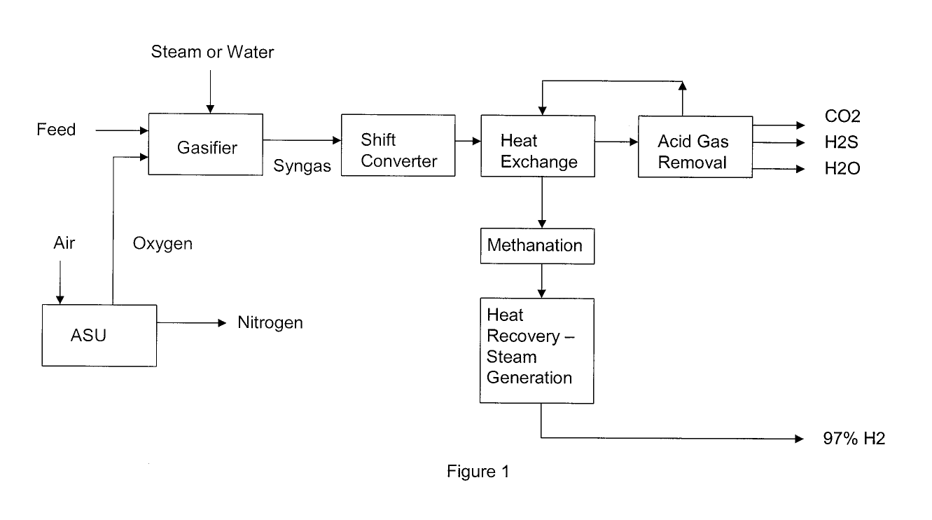

FIG. 2 illustrates a typical hydrogen production from a gasifier with PSA for hydrogen purification as known in the prior art.

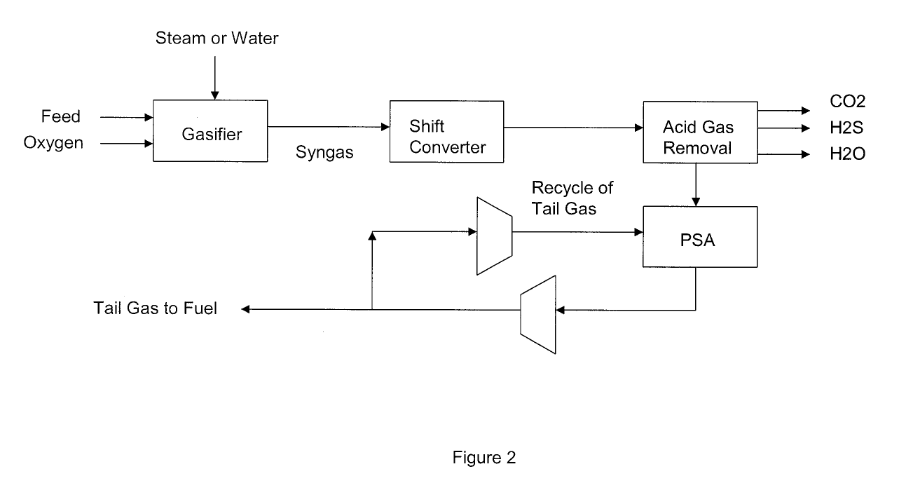

FIG. 3 illustrates one embodiment of the present invention, utilizing a cryogenic CO and Methane removal system.

FIG. 4 illustrates one embodiment of the present invention, utilizing cryogenic separation and a TSA.

### DESCRIPTION OF PREFERRED EMBODIMENTS

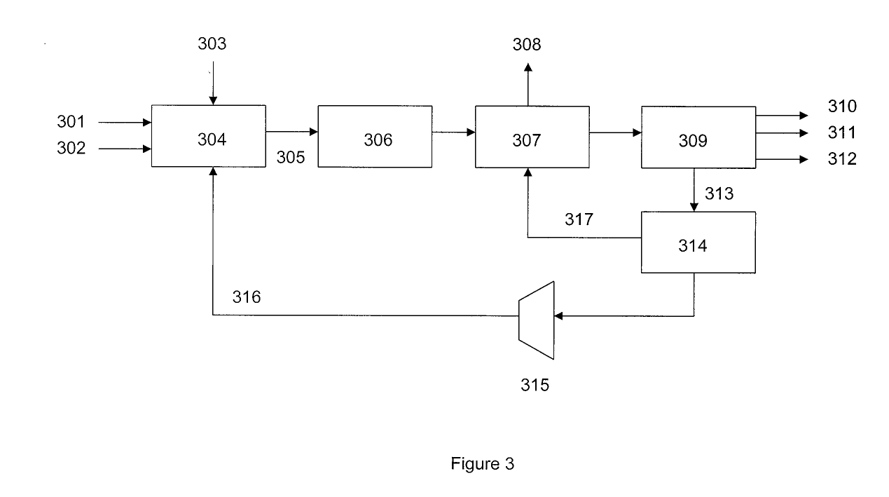

Turning now to FIG. 3, the invention is a process for production of hydrogen 317 from residual fuels 301. In the present invention, feedstock for the hydrogen production unit 301 can be refinery residues such as petroleum coke, visbreaker tar, pitch from deasphalting processes, vacuum residues, atmospheric residues and similar fuels or coal. The feed 301 is combined with oxygen 302 produced in an Air Separation Unit (ASU) (not shown). The purity of the ASU is adjusted in order to be in the range of 99% to 99.98% Oxygen. 99.5% Oxygen may be preferred considering power consumption in the ASU.

The oxygen 302 and the feed 301 are fed to the gasifier reactor 304. In some processes solid feeds are combined with water 303 to form a slurry. In other processes, solid or liquid feeds 301 are combined with steam 303 and oxygen 302 and fed to the gasifier reactor 304. In the gasifier reactor 304 the feed is converted to a raw syngas 305 comprised of hydrogen, carbon monoxide, carbon dioxide, methane, water and hydrogen sulfide. Residual argon and nitrogen coming in with the oxygen will also be present in the syngas. In some gasification processes, the syngas flows to a heat exchanger to produce steam (not shown). In other gasification process, the syngas is quenched directly with water to cool it down (not shown). Solids can be removed as a slag or through filtration of the resulting water.

The raw syngas 305 if then fed to a shift converter 306 where it is contacted with a catalyst to promote the water gas shift reaction. For quench systems, no additional steam is necessary for the shift reaction. If the syngas is used to produce steam in a heat exchanger, steam will need to be injected into the syngas upstream of the shift converter. The CO shift is done in multiple stages with intercooling between the two stages.

The residual CO at the outlet of the last stage is in the range of 0.2 to 2%. The product of the shift reactor will be mostly hydrogen, carbon dioxide, hydrogen sulfide, methane, residual carbon monoxide and the argon and nitrogen that entered with the oxygen and excess water. The shifted syngas is cooled down by indirect heat exchange 307. Indirect contact heat exchanger 307 then transfers heat indirectly between the BFW or other process streams 318 (not shown) and the hot shifted syngas stream thereby producing a cooled, shifted syngas stream and steam or other elevated temperature process streams 308. The cooled, shifted syngas stream is then fed to the acid gas removal (AGR) system 309 where excess water 312, carbon dioxide 310, and hydrogen sulfide 311 are removed, and raw hydrogen stream 313 is produced. If additional dryers are necessary, they may be added to the system as required by one skilled in the art.

Raw hydrogen stream 313 will contain un-shifted carbon monoxide, methane and mostly hydrogen along with residual nitrogen and argon. Methanol is the preferred solvent (e.g. Rectisol Process) for acid gas removal. When using methanol, the syngas stream is cooled to low temperatures, about −40° to about −60° C. There are other solvents such as Selexol and MDEA used for acid gas removal. The Selexol solvent operates in the range of about +10° to about −20° C., while MDEA based solvent run at ambient temperatures.

After acid gas removal, the vapor stream 313 containing hydrogen, methane, CO and residual argon and nitrogen is further purified by passing it over an adsorbent 314 at the low temperatures where the CO and methane are adsorbed. A multiple bed temperature-swing-adsorption (TSA) 314 unit may be used to remove the impurities. Methane is removed down to less than 1000 ppm, preferably below 100 ppmv. CO is removed down below 10 ppmv, preferably below 1 ppmv.

TSA 314 may be regenerated by either direct or indirect heat exchange with a warm fluid stream. In embodiments where TSA 314 is regenerated by direct heat exchange, the warm fluid stream may be, but is not limited to, a slip stream of hydrogen product gas In embodiments where TSA 314 is regenerated by indirect heat exchange, the warm fluid stream may be, but is not limited to, steam, ambient air, or the warm gas stream entering the AGR system.

Whereas, in the current state-of-the-art, the typical acid gas removal system (such as the Rectisol process) has an inlet gas stream at approximately ambient temperature, and a treated outlet gas stream also at approximately ambient temperature, the internal process is at temperature of about −40° to about −60° C. Typically if a temperature swing adsorption (TSA) unit is located downstream of the acid gas removal system, the ambient (or above ambient) temperature gas stream must again be cooled to approximately this same low temperature. One important aspect of the present invention is the thermal integration of the TSA with the AGR. According to the present invention, the low temperature TSA process is performed after the AGR process, but before the treated gas leaves the AGR system at ambient temperature. This improves the overall thermodynamic efficiency of the plant, among other things. This integration may be performed by any way known in the art.

Adsorption at cryogenic temperature in adsorbent 314 is a key part of this invention. The adsorption temperature range can be between about −100° to about +10° C. For methanol based acid gas removal processes (for example the Rectisol process), the gas out of the CO2 absorber is between about −40° and about −60° C., and can be sent directly to the TSA unit. Integration of cryogenic adsorption with chilled methanol acid gas removal process is also an important feature of this invention. The purified hydrogen at the outlet of TSA is sent back to the acid gas removal process for recovery of cold, as shown in FIG. 5. For other processes, such as Selexol or MDEA, the gas out of the absorber may have to be chilled down to the desired range of −40 to −60° C. before it is fed to the TSA unit.

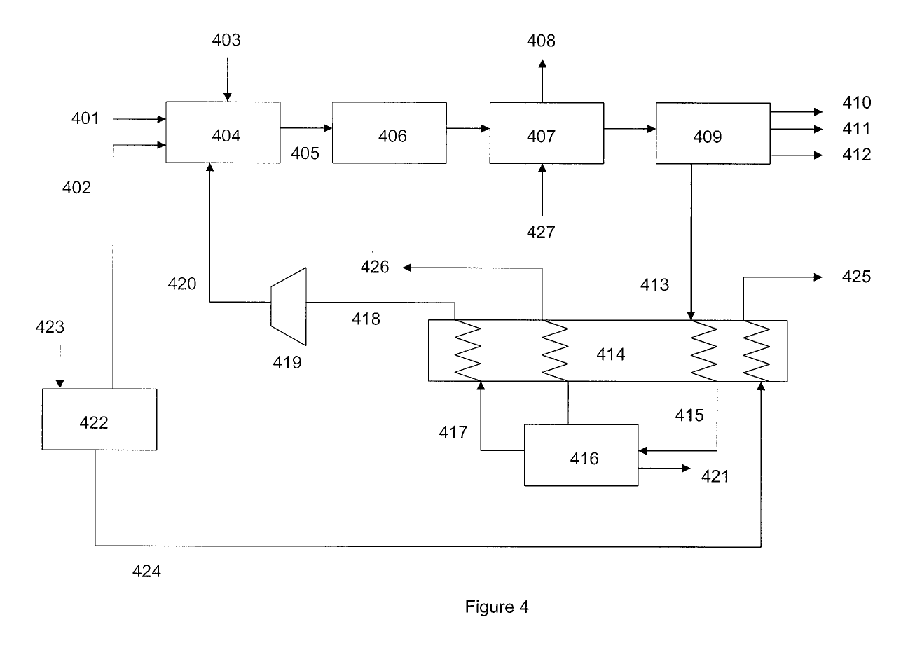

Turning now to FIG. 4, the invention is a process for production of hydrogen 426 from residual fuels 401. In the present invention, feedstock for the hydrogen production unit 401 can be refinery residues such as petroleum coke, visbreaker tar, pitch from deasphalting processes, vacuum residues, atmospheric residues and similar fuels or coal. The feed 401 is combined with oxygen 402 produced in an Air Separation Unit (ASU) 422. The purity of the oxygen 402 from ASU 422 is adjusted in order to be in the range of 99% to 99.98% Oxygen. 99.5% Oxygen may be preferred considering power consumption in the ASU.

The oxygen 402 and the feed 401 are fed to the gasifier reactor 404. In some processes solid feeds are combined with water 403 to form a slurry. In other processes, solid or liquid feeds 401 are combined with steam 403 and oxygen 408 and fed to the gasifier reactor 404. In the gasifier reactor 404 the feed is converted to a raw syngas 405 comprised of hydrogen, carbon monoxide, carbon dioxide, methane and hydrogen sulfide. Residual argon and nitrogen coming in with the oxygen will also be present in the syngas. In some gasification processes, the syngas flows to a heat exchanger to produce steam (not shown). In other gasification process, the syngas is quenched directly with water to cool it down (not shown). Solids can be removed as a slag or through filtration of the resulting water.

The raw syngas 405 if then fed to a shift converter 406 where it is contacted with a catalyst to promote the water gas shift reaction. For quench systems, no additional steam is necessary for the shift reaction. If the syngas is used to produce steam in a heat exchanger, steam will need to be injected into the syngas upstream of the shift converter. The CO shift is done in multiple stages with intercooling between the two stages.

The residual CO at the outlet of the last stage is in the range of 0.2 to 2%. The product of shift reactor 406 will be mostly hydrogen, carbon dioxide, hydrogen sulfide, methane, residual carbon monoxide and argon and nitrogen that entered with the oxygen and excess water. The shifted syngas is cooled down by indirect heat exchange 407. Indirect contact heat exchanger 407 then transfers heat indirectly between the BFW or other process streams 427 and the hot shifted syngas stream thereby producing a cooled, shifted syngas stream and steam or other elevated temperature process streams 408.

The cooled, shifted syngas stream is then fed to the acid gas removal system 409 where excess water 412, carbon dioxide 410, and hydrogen sulfide 411 are removed. The resulting hydrogen stream 413 will contain un-shifted carbon monoxide, methane and mostly hydrogen along with residual nitrogen and argon.

Methanol is the preferred solvent (e.g. Rectisol Process) for use in acid gas removal system 409. When using methanol, the syngas stream is cooled to low temperatures, about −40 to −60° C. There are other solvents such as Selexol and MDEA used for acid gas removal. The Selexol solvent operates in the range of between about +10° and about −20° C., while MDEA based solvent run at ambient temperatures.

After acid gas removal, the vapor stream 413, containing hydrogen, methane, CO and residual argon and nitrogen is cooled to cryogenic temperatures (approximately −160° C.) by indirect heat exchange in heat exchanger 414, against liquid nitrogen 424 from ASU 422 and with CO and Methane 417 from separation and TSA 416. The preferred cryogenic temperature, to TSA 416, would be between about −200° to about −60° C. The stream 416 temperature must be kept above the freezing temperature of methane at the given conditions for 416.

After cooling, vapor stream 415 is further purified by passing it over an adsorbent 416 at the low temperatures where the CO and methane are adsorbed. A multiple bed temperature-swing-adsorption (TSA) unit 416 may be used to remove the impurities. The cold waste gas (or purge gas) stream 421 containing hydrogen, nitrogen, argon, and CO may be sent to a boiler (not shown) or other source of combustion after recovery of cold in 414. Methane is removed down to less than 1000 ppm, preferably below 100 ppmv. CO is removed down below 10 ppmv, preferably below 1 ppmv.

Adsorption at cryogenic temperature in separation and TSA unit 416 is a key part of this invention. The adsorption temperature range can be about −200° to about −60° C. For methanol based acid gas removal processes, the gas out of the CO2 absorber is between about −40° and about −60° C., and can be sent directly to the TSA unit. Integration of cryogenic adsorption with chilled methanol acid gas removal process is also an important feature of this invention. The purified CO+methane stream 417 at the outlet of TSA 416 may be sent back to the acid gas removal process 409 for recovery of cold. For other processes, such as Selexol or MDEA, the gas out of the absorber may have to be chilled down to the desired range of about −40° to −60° C. before it is fed to the TSA unit. An interchanger that exchanges cold between the incoming gas and effluent from the TSA will reduce the load on the refrigeration unit.

Methanol wash and Selexol processes remove water along with acid gases. Dew point of the effluent from acid wash has to be kept in mind, as it should be lower than the adsorption temperature of the TSA unit. A drier may be required between the acid gas removal and cryogenic adsorption unit for removal of moisture and any residual CO2 that could freeze. The chilling of the gas can also be done by integrating it with ASU 422.

The CO and Methane stream 417 that is separated in separation unit 416 is sent to heat exchanger 414, where it exchanges heat with pure hydrogen stream 426, impure hydrogen steam 413 and liquid nitrogen stream 424. Resulting CO and Methane stream 418 may be compressed in compressor 419 and sent to gasifier 404. Nitrogen stream 424, from air separation unit 422, is sent to heat exchanger 414 where it is heated and vaporized, resulting in product gaseous nitrogen steam 425.

Once the adsorbent is loaded with impurities, it is taken off line and the impure hydrogen stream is switched to a regenerated bed of adsorbent. To regenerate the adsorbent, a stream of warm pure hydrogen is passed over the adsorbent bed to heat it up. As the adsorbent heats up, CO and methane and any argon, nitrogen and hydrogen present are desorbed from the adsorbent. The effluent from the regeneration is compressed and returned to the gasifier where the methane is converted to CO and Hydrogen.

Hydrogen recovery for this process is 90-100% with purity of 99.0 to 99.99% requirements. The ultimate purity is determined by the argon and nitrogen impurities coming in with the oxygen, and the extent of argon and N2 removal in the TSA. The recycle of methane and CO recovered in the TSA unit increases the overall hydrogen capacity of the unit for the same amount of residue fuel being gasified.

In a variation of the previous embodiment, the regeneration gas from the TSA is not recycled back to the gasifier, but is instead used as fuel for a process heater or a boiler raising steam (not shown). In this case the purity of this hydrogen can exceed 99.99%. The hydrogen recovery is dependent on the amount of impurities (Argon and Nitrogen) coming in with the oxygen, but can be as high as 95-99.9% with high purity oxygen.

What is claimed is:

1. A method of hydrogen and methane recovery from syngas from a gasifier, comprising;
a) directing a raw syngas stream from an acid gas removal system, said raw syngas stream comprising CO, methane, and hydrogen stream to a CO and methane removal system, thereby producing pure hydrogen stream and a stream comprising CO and methane; (should we include shift in this??)
b) returning said CO and methane stream to said gasifier, and
c) exporting said hydrogen stream as product.

2. The method of claim 1, wherein said syngas is produced in a hydrogen production unit from refinery residues that are selected from the group consisting of petroleum coke, visbreaker tar, pitch from deasphalting processes, vacuum residues, atmospheric residues, and coal.

3. The method of claim 1, wherein said CO and methane removal system comprises temperature swing adsorption unit.

4. The method of claim 3, further comprising an indirect heat exchanger that exchanges heat between said raw syngas prior to entry into said acid gas removal system, and said product hydrogen stream after exiting said temperature swing adsorption unit.

5. The method of claim 3, wherein said raw syngas stream exiting said acid gas removal system is at a temperature of between about −40 C and about −60 C.

6. The method of claim 5, wherein said raw syngas enters said temperature swing adsorption unit at a temperature of between about −40 C and about −60 C.

7. The method of claim 1, wherein said product hydrogen stream has less than about 10 ppmv of carbon monoxide.

8. The method of claim 7, wherein said product hydrogen stream has less than about 1 ppmv of carbon monoxide.

9. The method of claim 1, wherein said product hydrogen stream has a purity of between about 99.0% and about 99.99%.

10. The method of claim 9, wherein the hydrogen recovery of said method is greater than about 90%.

11. The method of claim 10, wherein said hydrogen recovery of said method is greater than about 95%.
